(19) United States
(12) Patent Application Publication
(10) Pub. No.: US 2026/0221644 A1
(43) Pub. Date: Jul. 30, 2026

(54) MODULAR EAS PEDESTAL

(71) Applicant: CHECKPOINT SYSTEMS, INC., Thorofare, NJ (US)

(72) Inventors: Nimesh SHAH, Cherry Hill, NJ (US); Peter SCHNEIDER, Neckargemuend (DE); Anthony PICCOLI, Barrington, NJ (US)

(21) Appl. No.: 19/148,776

(22) PCT Filed: Jan. 25, 2024
(86) PCT No.: PCT/US2024/012847

§ 371 Date: Jul. 17, 2025

Related U.S. Application Data
(60) Provisional application No. 63/441,567, filed on Jan. 27, 2023.

(51) Int. Cl. H01Q 1/24; G06K 7/10; H01Q 1/42

(52) U.S. Cl. CPC H01Q 1/24; G06K 7/10366; H01Q 1/42

(57) ABSTRACT

An EAS pedestal system is shown and described herein. The pedestal system comprises a base and an EAS antenna frame removably connected to the base. The removable frame allows for the frame to be dissociated from the base to allow access to the electronic components housed in the base or to replace the frame portion.

### CROSS-REFERENCE TO RELATED APPLICATIONS

The present application claims priority to and the benefit of U.S. Provisional Patent Application No. 63/441,567 entitled “Modular EAS Pedastal” filed on Jan. 27, 2023, the disclosure of which is incorporated herein by reference in its entirety.

### FIELD OF INVENTION

The present invention relates to an EAS pedestal. In particular, the present invention relates to an EAS pedestal system having an antenna frame that is releasable from a base so as to allow the frame to be removed and optionally replaced with another frame.

### BACKGROUND

Electronic article surveillance (“EAS”) systems are commonly used in retail stores and other settings to prevent the unauthorized removal of goods from a protected area. Typically, a detection system is configured at an exit from the protected area, which comprises one or more transmitters and antennas (“pedestals”) capable of generating an electromagnetic field across the exit, known as the “interrogation zone.” Articles to be protected are tagged with an EAS marker that, when active, generates a response signal when passed through this interrogation zone. An antenna and receiver in the same or another “pedestal” detects this response signal and generates an alarm.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

The present invention provides an EAS pedestal system with a frame section that is separate from and detachable from a base. Conventional EAS antenna pedestals systems are generally single units that houses all the components and electronics for the antenna to function. The single unit is positioned at a desired location and the appropriate wiring and connections made. Where the EAS pedestal is damaged or in need of repair, the entire unit must be removed and/or replaced. Similarly, where the interior of a store is being updated or remodeled, the aesthetics, e.g., the shape, color, or other appearance, of the old pedestals may be undesirable. Providing a pedestal with a new look or design requires complete removal of the pedestal and replacement with an entirely new unit. Similarly, upgrading a pedestal to provide new functionality, e.g., video display or monitoring, requires replacing the entire EAS pedestal. This may require other labor and costs to cut flooring to replace cabling, which subsequently requires repairing the floor.

The present technology provides an EAS pedestal system comprising a base section and an EAS antenna frame that is detachable from the base. The base houses the core electronic components. The frame can be removed from the base and a new frame can be attached to the base, where a need arises to change the look of the pedestal or to replace a damaged pedestal.

The present technology provides an EAS pedestal system with an EAS antenna frame that is modular, interchangeable, or replaceable while not having to swap out or change the base section and the electronics contained therein. This can reduce the costs and time associated with changing or replacing an EAS pedestal as there may only be need to change the frame portion of the system. Even if new wiring or electronic connections are required to provide an EAS frame with desired functionality (e.g., upgrading to RFID, providing a frame with graphics or video functionality, etc.), there is a reduction in time and costs if only the frame portion is being replaced.

In accordance with an embodiment, there is provided an interchangeable EAS pedestal system comprising a base and a frame, wherein the frame is releasably connected to the base.

In one embodiment, the base comprises a lower base section configured to contact a surface and to support the pedestal system, and a first side and a second side opposite the first side, wherein the first and the second sides extend upward from the lower base section, and wherein the frame comprises a first side and a second side opposite the first side, the first and second sides of the frame being disposed about the first and second sides of the base.

In one embodiment, the base comprises a first vertical arm proximate to a first end of the base, and a second vertical arm proximate to a second end of the base; and the frame comprises a first side and a second side opposite the first side, the first side of the frame defining a vertical slot, the vertical slot configured to receive the first vertical arm of the base.

In one embodiment, the second side comprises a second vertical slot, wherein the second vertical slot is configured to receive the second vertical arm of the base.

In one embodiment, the frame is connected to the base via one or more fasteners.

In one embodiment, the frame defines an area providing a point of access to the one or more fasteners.

In one embodiment, the frame comprises a cover section removably attached to the frame and covering the area.

In one embodiment, the cover section comprises a first section disposed proximate to an upper section of the frame, and a second section disposed beneath the first section, wherein first section is removable from the frame, and the second section is slidable along a vertical axis of the frame when the first section is removed from the frame to expose or conceal an area providing a point of access to one or more fasteners.

In one embodiment, the frame comprises an upper end, a lower end, a first side disposed between the upper and lower end, and a second side disposed between the upper and lower end and opposite the first side, the first and second sides each comprising a first cover section extending substantially along a length of the respective first and second sides, and a second cover section disposed over the upper end, wherein when the second cover section is removed, the first cover sections are slidable along a vertical axis of the frame.

In one embodiment, the second cover section comprises a pair of corner sections and a middle section therebetween, wherein the corner sections are detachable from the middle section, and wherein the first cover sections are configured to slide upward when the corner sections are detached from the middle section.

In one embodiment, the base comprises a lower base support section, a first vertical arm proximate a first end of the lower base support section, and a second vertical arm proximate a second end of the lower base support section, the first vertical arm and the second vertical arm each having a profile configured to support a lower section of the frame to grant access to an interior of the base such that the base is in an open, exposed configuration.

In one embodiment, the profile comprises a slot configured to receive an edge of the lower section of the frame to maintain the base in the open, exposed configuration.

In one embodiment, the base comprises a lower base support section, a first vertical arm proximate a first end of the lower base support section, and a second vertical arm proximate a second end of the lower base support section, the first and second vertical arms each comprising a leaf spring configured to support a lower section of the frame to grant access to an interior of the base such that the base is in an open, exposed configuration.

In one embodiment, the leaf spring is biased with a spring force to maintain the frame in the open, exposed configuration when the lower section of the pedestal frame rests upon the leaf springs.

In one embodiment, the frame a first side and a second side, wherein a tether is attached to one of the first and second sides and is configured to engage with the base to inhibit the frame from being freely disassociated from the base.

In one embodiment, the base comprises a lower base section and first and second arms extending upward from the lower base section, wherein one of the first and second arms define a slot dimensioned to receive the tether therethrough.

In one embodiment, the base comprises electronic components for powering the EAS pedestal system, and wherein the frame is electrically connected to the electronic components in the base.

In one embodiment, the frame is removeable from the EAS pedestal system, and is replaceable with a different frame.

In an accordance with an embodiment, a method of reconfiguring an EAS pedestal system comprises providing an EAS pedestal system comprising a base and a first frame removably connected to the base; removing the first frame from the base; and connecting a second frame to the base.

In one embodiment, base comprises a pair of arms extending upward dimensioned to engage with the first frame or the second frame.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is front view of an EAS pedestal system in accordance with an embodiment of the technology;

FIG. 2 is a side view of the EAS pedestal of FIG. 1;

FIG. 3 an exploded view of the EAS pedestal system of FIGS. 1 and 2;

FIG. 4 is an exploded view of the EAS pedestal system of FIGS. 1-3;

FIG. 5 is an exploded view of a lower portion of the EAS pedestal system of FIGS. 1-4;

FIG. 6 is a perspective view of an embodiment of an EAS pedestal system;

FIG. 7 is an exploded view of a lower section of the EAS pedestal system of FIG. 6;

FIG. 8 is a perspective view of an embodiment of a frame cover for an EAS pedestal system;

FIG. 9 is an exploded view of a lower section of the EAS pedestal system of FIG. 8;

FIG. 10 is a perspective view of an embodiment of a frame cover for an EAS pedestal system;

FIG. 11 is a perspective view of an embodiment of a frame cover for an EAS pedestal system;

FIG. 12 is a perspective view of an embodiment of a frame cover for an EAS pedestal system;

FIG. 13 is a view of a section of the EAS pedestal system of FIG. 12;

FIG. 14 is a perspective view of an embodiment of a frame cover for an EAS pedestal system;

FIG. 15 is an exploded view of an upper section of the EAS pedestal system of FIG. 14;

FIG. 16 is a view of a lower section of the EAS pedestal system of FIG. 14;

FIG. 17 is a perspective view of an embodiment of a frame cover for an EAS pedestal system;

FIG. 18 is an exploded view of the pedestal system of FIG. 17;

FIG. 19 is an exploded view of the pedestal system of FIG. 17;

FIG. 20 is an exploded view of an upper section of the EAS pedestal system of FIG. 20 with a modified detachment system;

FIG. 21 is a view of a lower section of the EAS pedestal system of FIG. 20;

FIG. 22 is a perspective view of a base section of a EAS pedestal system in accordance with an embodiment of the present technology;

FIG. 23 is a perspective view of the base of FIG. 22 supporting a frame member;

FIG. 24 is a perspective view of the base of FIG. 22 supporting a frame member;

FIG. 25 shows the lower portion of an EAS pedestal system with a base comprising a frame support member;

FIG. 26 is a view of a lower section of an EAS pedestal system comprising a tether;

FIG. 27 is a view of the system of FIG. 26; and

FIG. 28 is a view of the system of FIG. 26.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is an EAS pedestal system that includes a pedestal frame that is detachable from a pedestal base. The EAS pedestal system allows for an EAS antenna frame to be detached from the base. The system with the EAS antenna frame that is detachable from a base provides, in one embodiment, a system that allows for the frame to be removed from the base to replace the antenna frame. For example, if the antenna frame is damaged or if it is desired to utilize a pedestal frame with a different visual appearance or different functionality (e.g., graphics, video display, video monitoring, etc.), the frame can be removed and replaced or changed out with a new frame without the need to completely replace the entire pedestal system (including the electronic components of the system).

The EAS pedestal system with the detachable EAS antenna frame also allows for a frame to be replaced with a different frame that could have a different visual appearance, functionality, or other features. For example, a retail environment may want an updated look to the antenna to comport with changes being made to the interior of the store such as the colors of the store interior or to provide a shape or contours that match the lines or contours of the store's aesthetics. It may also be desirable to change an antenna to provide different functionality such as, for example graphic or visual displays including, for example, advertising or other information, or providing an antenna frame that has video display or video monitoring capabilities. The EAS pedestal system, therefore, provides a modular system that can be changed or reconfigured as desired by an end user.

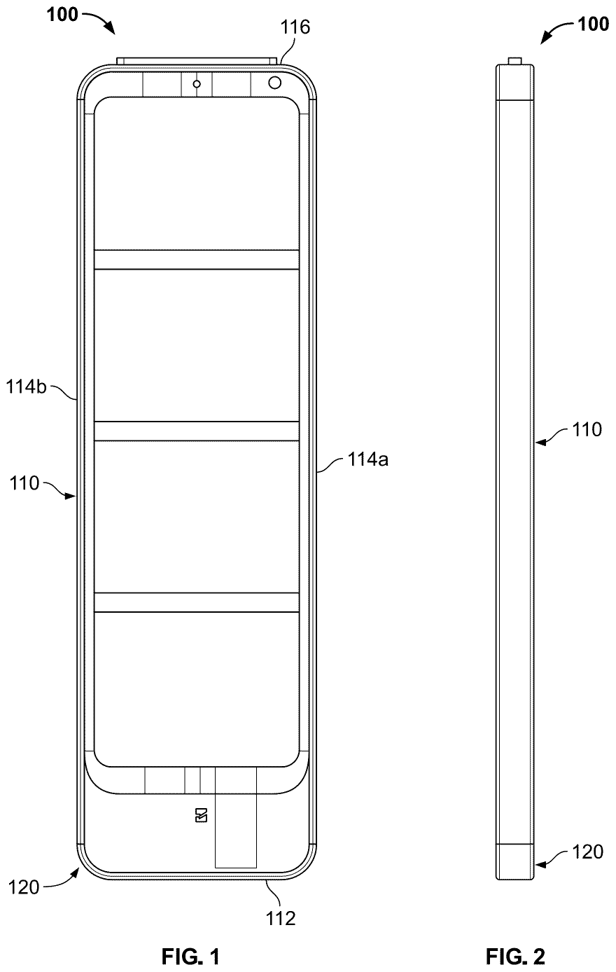

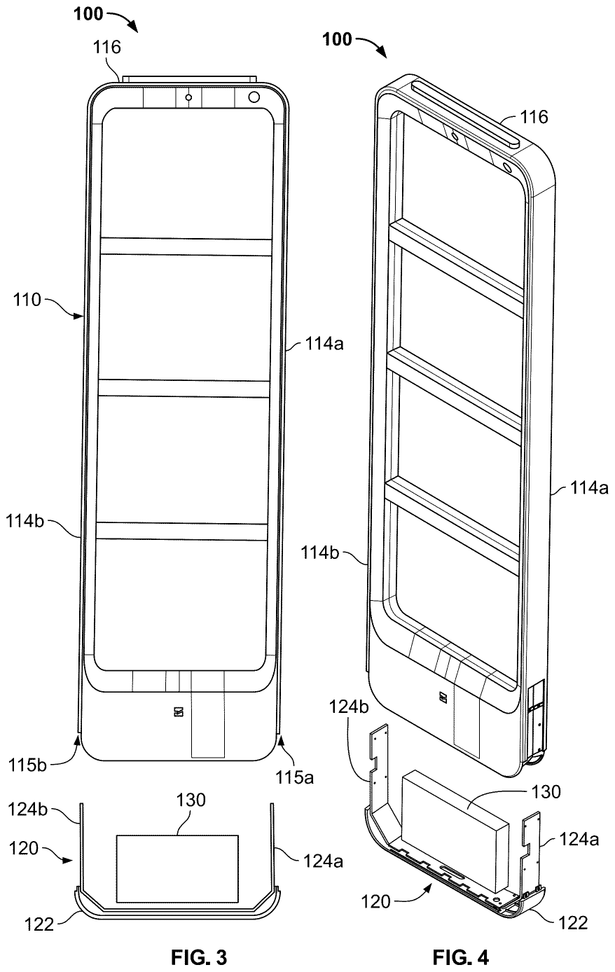

FIGS. 1-5 show an embodiment of an EAS pedestal system in accordance with aspects of the present technology. The pedestal system 100 includes an EAS antenna frame 110 and a base 120. The EAS antenna frame 110 is configured to be releasably connected to the base 120. The base 120 includes a lower base section or support 122 (FIG. 3) that will contact the ground and provide a base support for the EAS pedestal system. The base 120 includes a frame with sides 124a and 124b extending vertically from the base support 122. The EAS antenna frame 110 includes a lower end 112, an upper end 116, and opposing sides 114a and 114b disposed between the lower end 112 and the upper end 116. The sides 114a and 114b define an opening or slot 115a and 115b (FIG. 3), respectively configured to slidingly engage sides 124a and 124b, respectively, of the base 120.

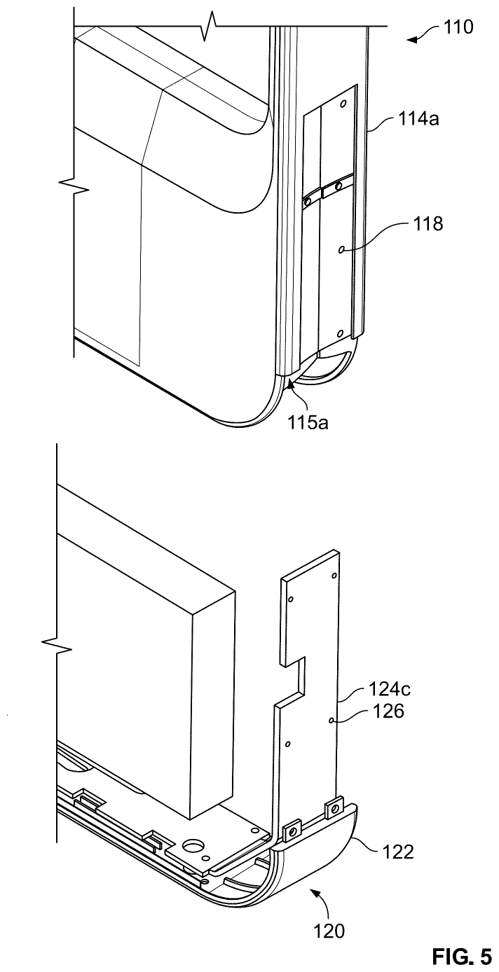

The EAS pedestal system can be provided by sliding the EAS frame 110 onto the base 120 such as by inserting the sides 124a and 124b into slots 115a and 115b, respectively, of the EAS antenna frame 110. The sides 124a, 124b and sides 114a, 114b can be provided with apertures 118, 126 (FIG. 5) through which a fastener can be inserted to securely fasten and attach the frame 110 to the base 120. The apertures 118 in the sides 114a, 114b of the frame 110 are configured and positioned to align with the apertures 126 in the sides 124a, 124b of base 120. The type of fastener is not particularly limited and can be selected as desired for a particular purpose or intended application.

The antenna frame in the detachable EAS pedestal system can be configured in any suitable manner to allow for the frame to be detached and removed from the base. In one aspect, the frame can be configured to deny or limit access to the fasteners securing the frame to the base. That configuration is not necessarily limited. A variety of configurations could be selected to provide access to the fasteners.

The base includes the primary electronics 130 (FIGS. 3 and 4) for the pedestal system. The frame may include electronics for any desired functionality, and the frame can be electrically connected to the base in any suitable manner as desired to provide the system with the desired functionality.

It will be appreciated that the manner in which the frame is configured to fit with the base is not particularly limited. While the embodiments in FIGS. 1-5 and generally the additional embodiments illustrated herein show the frame configured with the slots or channels that slide over the arms of the base, other configurations are within the scope of the invention. For example, depending on how the electronics are situated within the base, the frame 110 could be configure to slide on the inner surface of the arms 124a, 124b such that the arms 124a, 124b would be exterior to the frame 110 in that region. A cover could be placed over that section of the arms 124, 124b as would be desirable to cover the exposed portion of the base. In another embodiment, the frame may be configured with an opening between the inner walls of the frame in the lower region, and the inner surface of the frame is positioned over the arms of the base.

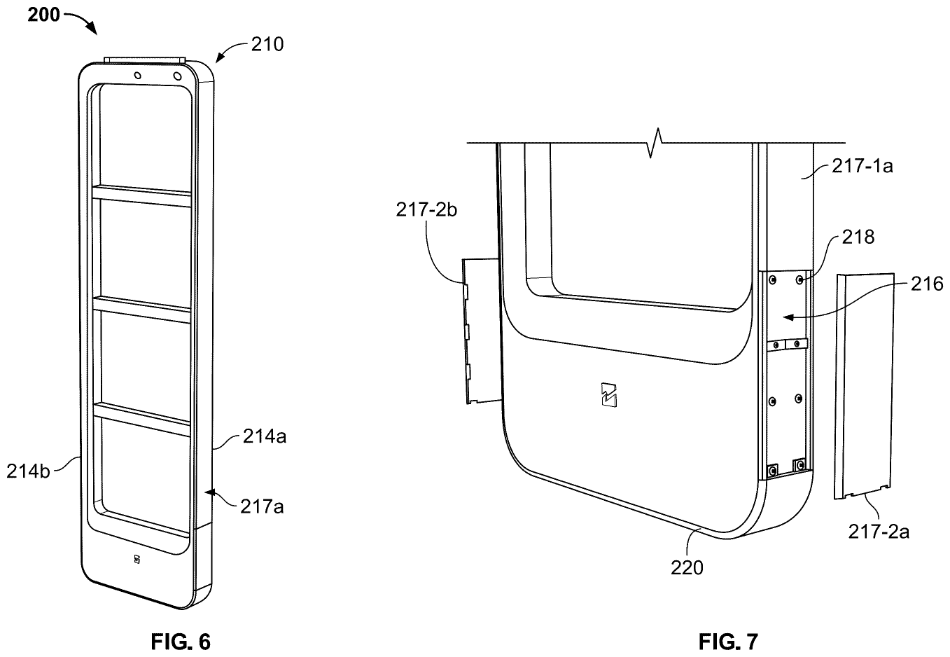

FIGS. 6 and 7 show a pedestal system 200 that includes a frame 210 having sides 214a and 214b releasably attached to a base 220. The sides 214a, 214b of the frame define recessed areas 216 (e.g., fastener access areas) that are dimensioned to be enclosed with cover sections 217a, i.e., sections 217-1a and 217-2a in the embodiment shown. Section 217-1a is generally fixed in place. Section 217-2a is a detachable cover that is removable from the frame 210 to expose the recessed areas 216 and fasteners 218 securing the frame 210 to the base 220. Cover section 217-2a may be, for example, a piece configured to be snap fit onto the frame. FIG. 7 shows the cover section 217-2b on the opposite side of the frame.

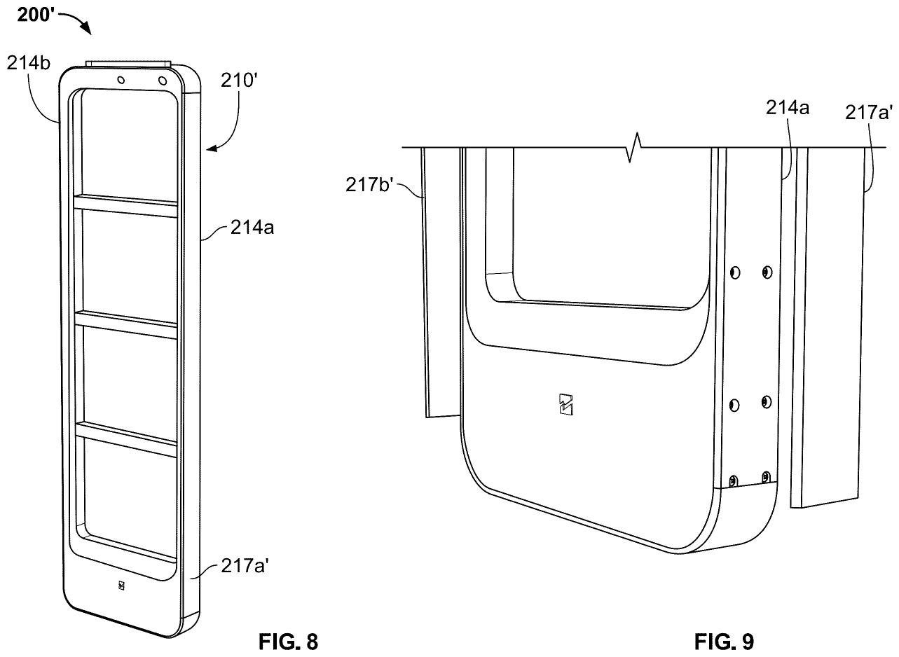

FIGS. 8 and 9 shows a pedestal system 200′ that is similar to system 200 in FIGS. 6 and 7. The pedestal system 200′ includes a frame 210′ that includes cover sections 217a′ and 217b′. The cover sections 217a′ and 217b′ are single piece units that extend substantially the length of the sides 214a and 214b, respectively. The cover sections 217a′ and 217b′ are configured to detach from the frame 210′ to expose and provide access to the fasteners. The frame can be configured for the cover sections 217a′ and 217b′ to be snap fit into place around the sides 214a and 214b, respectively. In the embodiment shown in FIG. 9, the sides 214a, 214b are configured with apertures to receive fasteners for securing the frame to the base. The apertures and fasteners are concealed when the cover sections 217a′ and 217b′ are attached to the sides 214a, 214b. The cover sections 217′ can be made from any suitable material such as a plastic or rubber material. Depending on the properties of the materials the cover sections 217′ can serve as a bumper to provide additional protection to the sides of the frame.

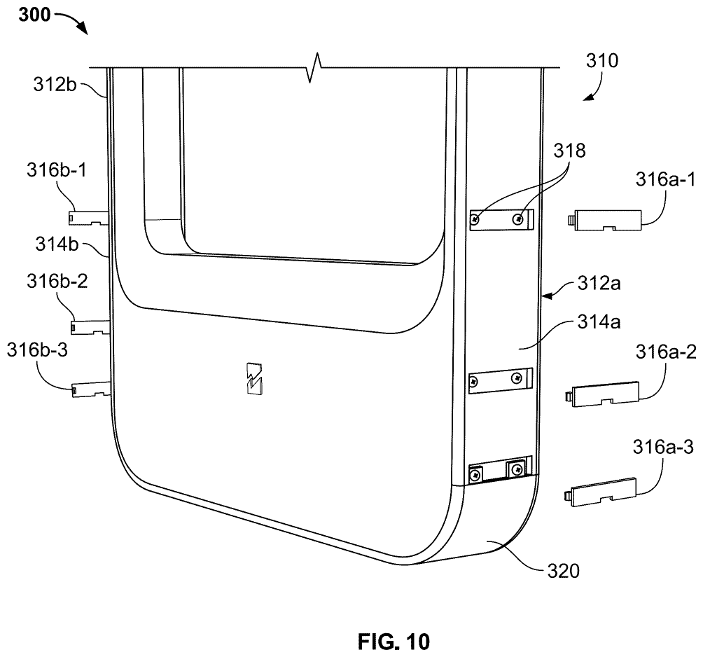

FIG. 10 shows the lower portion of a pedestal system 300 that includes a frame 310 that is detachable from a base 320. The frame 310 includes opposing sides 312a and 312b having covers 314a and 314b respectively. The side covers 314a and 314b include a plurality of snap fit covers positioned to cover the fasteners 318 that are used to secure the frame to the base. In the embodiment shown in FIGS. 8 and 9, the frame includes three snap fit covers (316a-1, 316a-2, 316a-3, 316b-1, 316-2, and 316b-3) covering openings that are configured with the apertures for securing the frame to the base with the fasteners 318.

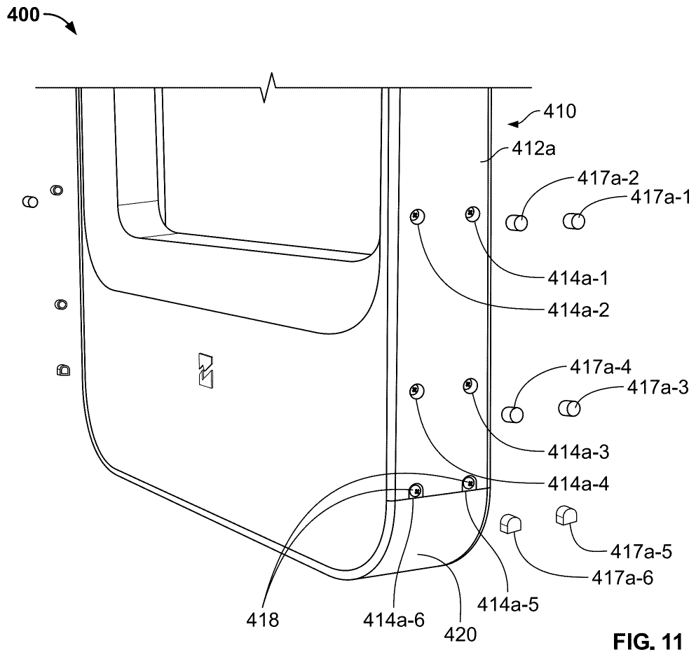

FIG. 11 shows the lower portion of a pedestal system 400 having a frame 410 and a base 420. The sides of the frame include a cover with apertures in alignment with the areas where the fasteners for fastening the frame to the base are provided and separate plugs to the individually cover the fasteners. FIG. 11 shows one side of the frame. Side 412a defines a cover that includes apertures 414a-1 through 414a-6 positioned to align with the fasteners 418 in those respective areas. A plug is provided to be inserted into the respective apertures and cover the fasteners. In FIG. 11, the system includes rubber gaskets 417a-1 through 417a-6 that fit into the apertures 414a-1 through 414a-6, respectively. It will be appreciated that the “plug” need not be a rubber gasket, but any suitable plug can be employed to be inserted into the respective apertures.

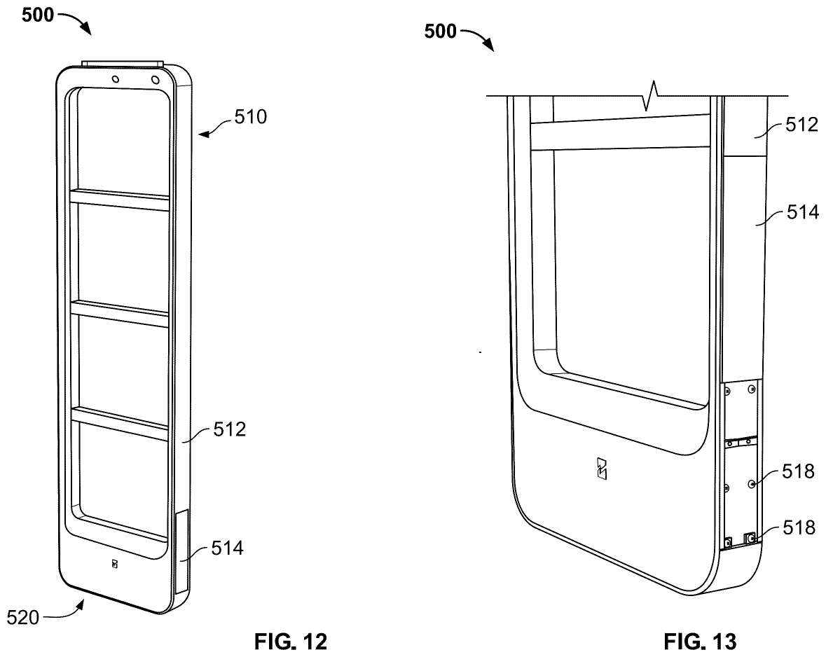

FIGS. 12 and 13 show another embodiment of a configuration for the side of the frame. The pedestal system 500 includes frame 510 and base 520. The sides 512 of the frame include a cover section 514 that is slidable along the side 512. When the cover section 514 is slid upward, the section of the frame having the fasteners 518 for securing the frame to the base is exposed. The sides 512 can be configured in any suitable manner to allow for cover section 514 to move in sliding engagement along the side. A slot can be formed in the frame to accommodate the cover section 514. The cover section can slide over a portion of the side 514 to expose the fasteners in the frame and base.

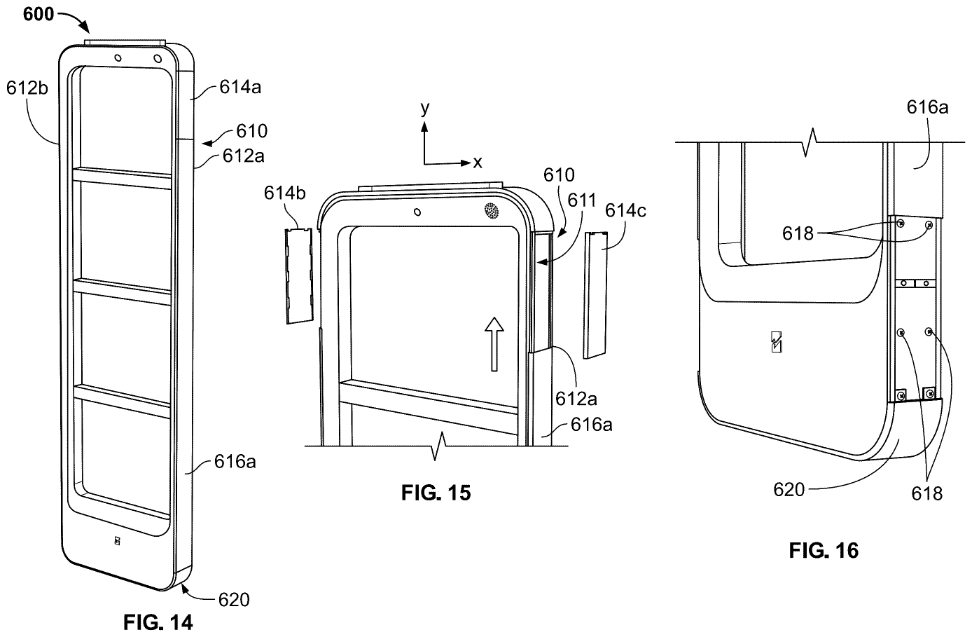

FIGS. 14-16 show an EAS pedestal system 600 having an antenna frame 610 and a base 620. The frame 610 is releasably associated with the base 620. The frame 610 includes a first side 612a and a second side 612b. The sides are configured to allow access to the fasteners securing the frame 610 to the base 620 and to allow for the frame to be removed from the base. The sides are configured with a two-piece system comprising an upper removable cover section (614a, 614b) and cover section (616a as shown in FIGS. 14-16) that is vertically slidable along the length of the sides. FIG. 15 shows the upper removable cover sections 614a, 614b detached from the side of the frame. When the upper cover sections 614a, 614b are removed from the frame, a space 611 is provided that allows the cover section 616a to freely slide vertically along the frame, for example upward in a direction substantially parallel with a vertical axis y of the frame. When the cover section 616a is slid upward in this manner, the fasteners 618 securing the frame to the base can be exposed (FIG. 16).

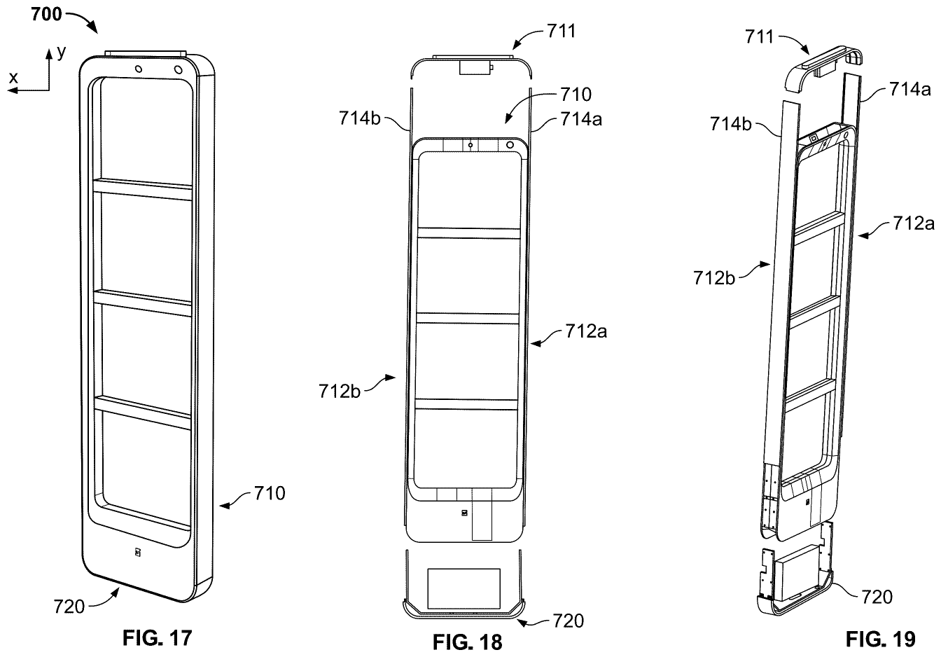

FIGS. 17-21 show an EAS pedestal system 700 having a different configuration to allow removal of the fasteners 718 to allow for the frame to be detached from the base. The pedestal system 700 includes a frame 710 releasably connected to a base 720. The frame has opposing vertical sides 712a and 712b (FIG. 18). The frame includes an upper cover section 711 and side covers 714a and 714b. The upper cover section 711 is removable from the frame, and the side covers 714a and 714b are slidable along the sides 712a and 712b, respectively, of the frame 710. To remove the frame from the base, the upper cover section 711 is removed, the side covers 714a and 714b are slid upward (e.g., in a direction substantially parallel with a vertical axis y of the frame) to expose the fasteners 718, and the fasteners can be removed as needed.

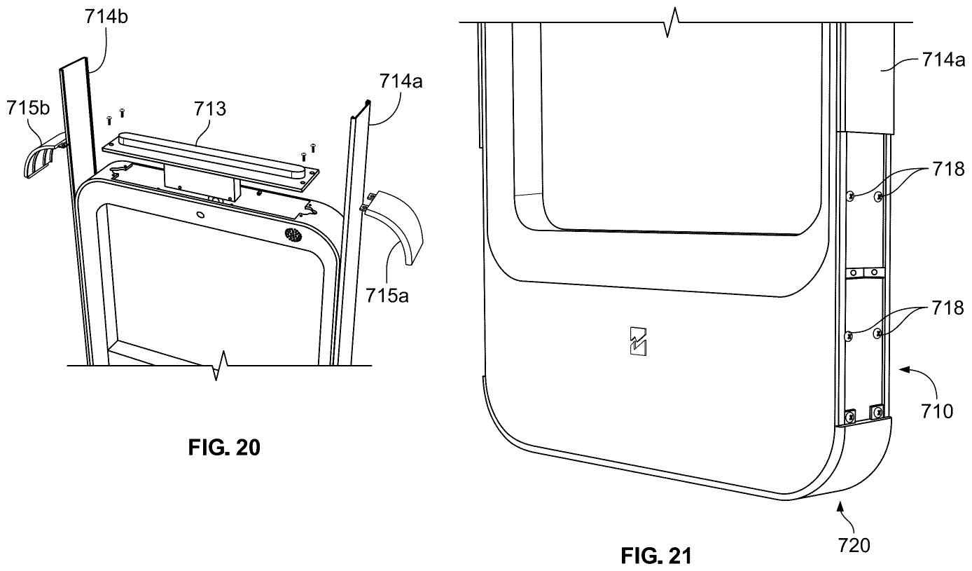

In the embodiment shown in FIGS. 20 and 21, the upper cover section is provided in sections with a middle section 713 (FIG. 20) and corner sections 715a and 715b. The corner sections 715a and 715b are detachable from the middle section 713. The corner sections are detached from the middle section and the frame to allow the side covers 714a and 714b to be slid upward to allow the fasteners connecting the frame and the base to be exposed (FIG. 21).

In the operation of attaching the EAS antenna frame to a base, it may be necessary to electrically connect the frame to the electronic components housed in the base of the system. It may also be necessary, at times, to have access to the electronics housed in the base such as, for example to repair or replace the electronic components. For installation or repair of components in the base, it may be desirable that the frame section be physically proximate to the base. It may not be practical or even desirable to have the frame section located away from the base or separately standing on the ground nearby. Along these lines, the base can be configured to allow for the frame to rest on the base but in a position that allows access to the components located within the base.

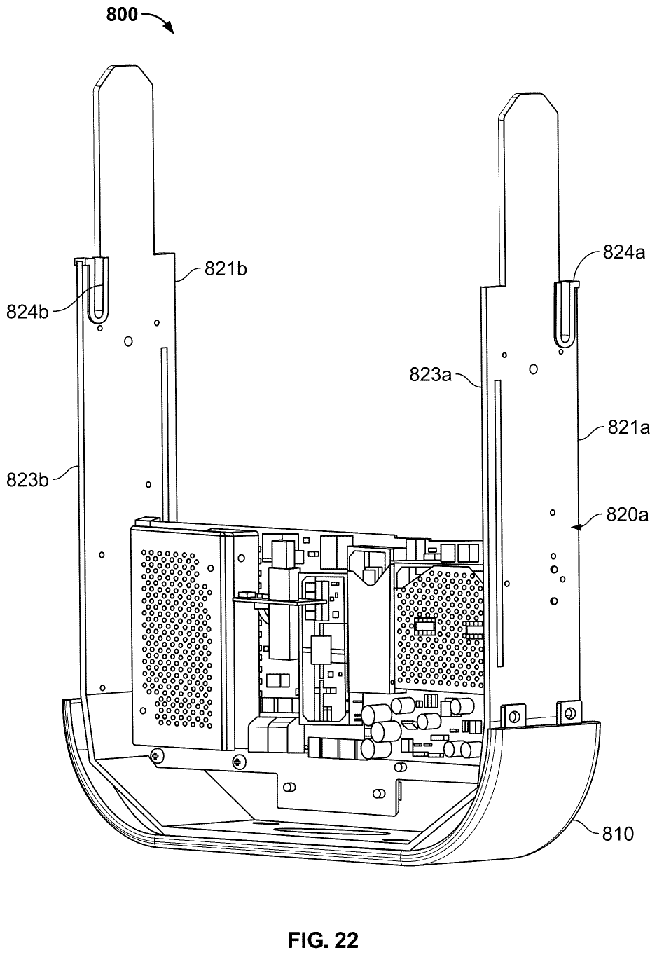

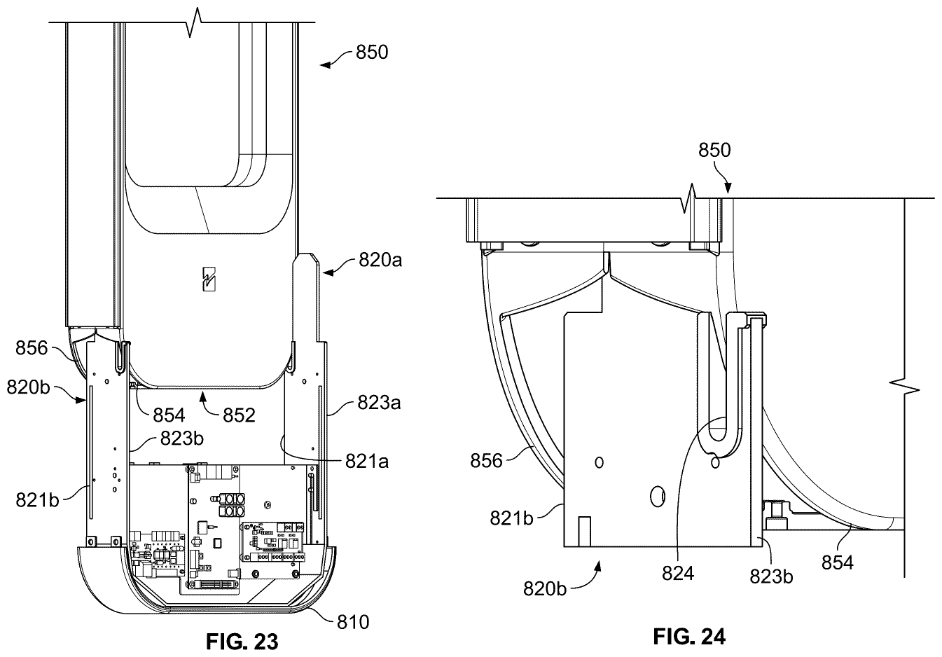

In one embodiment, the base can be configured with a profile to allow the frame to be supported on the base such that the pedestal is “open” to allow access to the interior of the base. The profile could be a ledge, slot, groove, etc. that can contact and hold the frame in an open position. In one embodiment, the base is provided with grooves disposed in the vertical sides that can receive an edge portion of the antenna frame and support or otherwise hold the frame and allow the interior of the base section to be exposed. FIGS. 22-24 show a base section 800 having a bottom end 810 and opposing vertical ends 820a and 820b. Ends 820a and 820b are in the form of vertical support arms. The support arms 820a and 820b each have opposing sides (821a and 823a, and 821b and 823b, respectively). Grooves or slots 824a and 824b are formed in the side arms 820a and 820b respectively. In the embodiment of FIGS. 22-24, groove 824a is disposed on side 821a, and groove 824b is disposed on side 823b such that the grooves are on opposite sides relative to one another (i.e., diagonal to each other). A frame 850 may be provided with a lower end 852 having edges 854 and 856. The frame is provided such that the edges are deep enough to be received and supported by the grooves 824a and 824b. An edge of the frame, e.g., edge 854, can be positioned in grooves 824a and 824b such that base 800 can support the frame 850 to allow access to the interior of the base. This can allow the frame to be positioned on the base during installation of and/or removal of the frame from the base. The grooves could be aligned on both sides. Further, the depth and shape of the grooves could be selected as desired.

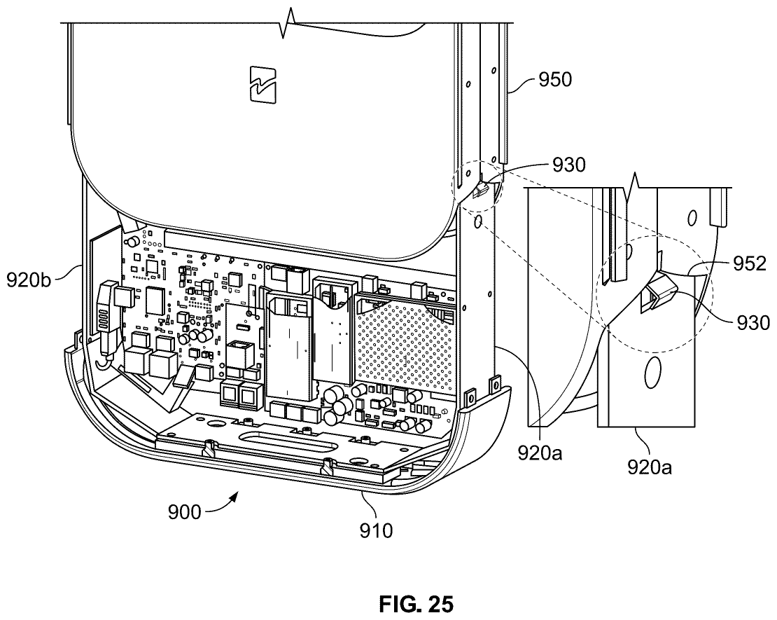

In another embodiment, the vertical sides of the base are provided with a leaf spring configured to support the base. FIG. 25 shows an embodiment of a base 900 comprising a lower support end 910 and opposing sides 920a and 920b extending vertically from end 910. The base is provided with a leaf spring 930 disposed in each of the sides 920a and 920b. The leaf spring 930 is configured such that it can support the weight of the antenna frame when a section 952 of the antenna frame is in contact with and resting upon the leaf spring 930. To complete the installation of the frame onto the base, sufficient downward force must be applied to overcome the spring force of the leaf spring 930.

The system can include other features as may be desired for a particular use or intended application. In one embodiment the pedestal system can include a tether to tether the antenna frame to the base. This may be useful to prevent movement of the frame relative to the base to a sufficient degree such that the frame cannot be lifted away from the base past a certain distance or with too high a force that would result in damage to the cables, connectors, and electronic components.

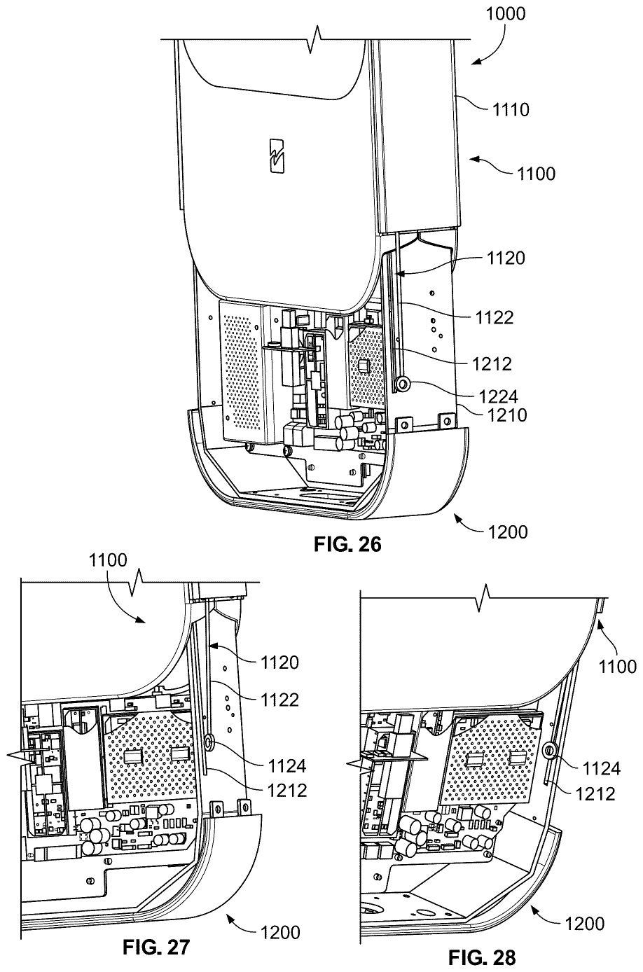

FIGS. 26-28 show a system 1000 comprising a frame 1100 and a base 1200. The frame includes a tether 1120 attached to an inner surface of side wall 1110 of frame 1100. The tether includes an elongated arm 1122 and a tab 1124 at its free end. The base 1200 includes a vertical side 1210 that includes a slot 1212. The slot is sized such that the tether 1120 can be disposed through the slot. The tether can be inserted into the slot by rotating the tether to orient the tab 1124 such that it will fit through the slot 1212. After inserting the tab 1124 into the slot 1212, the tab can be rotated such that its width is greater than the slot. In this position, the tab engages an inner surface of side 1210 of base 1200, and the tether cannot be removed therefrom. The tether can be removed, so as to allow for the frame to be disassociated with the system, by a user rotating the tether such that tab is oriented to fit through the slot and be removed from therefrom.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an EAS pedestal system. Modifications may occur to those skilled in the art and to those who may make and use the invention. The disclosed embodiments are merely for illustrative purposes and not intended to limit the scope of the invention or the subject matter set forth in the claims.

1. An interchangeable EAS pedestal system comprising:
a base; and
a frame, wherein the frame is releasably connected to the base.

2. The interchangeable EAS pedestal system of claim 1, wherein the base comprises
a lower base section configured to contact a surface and to support the pedestal system, and a first side and a second side opposite the first side, wherein the first and the second sides extend upward from the lower base section, and wherein the frame comprises a first side and a second side opposite the first side, the first and second sides of the frame being disposed about the first and second sides of the base.

3. The interchangeable EAS pedestal system of claim 1, wherein the base comprises a first vertical arm proximate to a first end of the base, and a second vertical arm proximate to a second end of the base; and the frame comprises a first side and a second side opposite the first side, the first side of the frame defining a vertical slot, the vertical slot configured to receive the first vertical arm of the base.

4. The interchangeable EAS pedestal system of claim 3, wherein the second side comprises a second vertical slot, wherein the second vertical slot is configured to receive the second vertical arm of the base.

5. The interchangeable EAS pedestal system of claim 4, wherein the frame is connected to the base via one or more fasteners.

6. The interchangeable EAS pedestal system of claim 5, wherein the frame defines an area providing a point of access to the one or more fasteners.

7. The interchangeable EAS pedestal system of claim 6, wherein the frame comprises a cover section removably attached to the frame and covering the area.

8. The interchangeable EAS pedestal system of claim 7, wherein the cover section comprises a first section disposed proximate to an upper section of the frame, and a second section disposed beneath the first section, wherein first section is removable from the frame, and the second section is slidable along a vertical axis of the frame when the first section is removed from the frame to expose or conceal an area providing a point of access to one or more fasteners.

9. The interchangeable EAS pedestal system of claim 1, wherein the frame comprises an upper end, a lower end, a first side disposed between the upper and lower end, and a second side disposed between the upper and lower end and opposite the first side, the first and second sides each comprising a first cover section extending substantially along a length of the respective first and second sides, and a second cover section disposed over the upper end, wherein when the second cover section is removed, the first cover sections are slidable along a vertical axis of the frame.

10. The interchangeable EAS pedestal system of any of claim 9, wherein the second cover section comprises a pair of corner sections and a middle section therebetween, wherein the corner sections are detachable from the middle section, wherein the first cover sections are configured to slide upward when the corner sections are detached from the middle section.

11. The interchangeable EAS pedestal system of claim 1, wherein the base comprises a lower base support section, a first vertical arm proximate a first end of the lower base support section, and a second vertical arm proximate a second end of the lower base support section, the first vertical arm and the second vertical arm each having a profile configured to support a lower section of the frame to grant access to an interior of the base such that the base is in an open, exposed configuration.

12. The interchangeable EAS pedestal system of claim 11, wherein the profile comprises a slot configured to receive an edge of the lower section of the frame to maintain the base in the open, exposed configuration.

13. The interchangeable EAS pedestal system of claim 1, wherein the base comprises a lower base support section, a first vertical arm proximate a first end of the lower base support section, and a second vertical arm proximate a second end of the lower base support section, the first and second vertical arms each comprising a leaf spring configured to support a lower section of the frame to grant access to an interior of the base such that the base is in an open, exposed configuration.

14. The interchangeable EAS pedestal system of claim 13, wherein the leaf spring is biased with a spring force to maintain the frame in the open, exposed configuration when the lower section of the pedestal frame rests upon the leaf springs.

15. The interchangeable EAS pedestal system of claim 1, wherein the frame comprises a first side and a second side, wherein a tether is attached to one of the first and second sides and is configured to engage with the base to inhibit the frame from being freely disassociated from the base.

16. The interchangeable EAS pedestal system of claim 15, wherein the base comprises a lower base section and first and second arms extending upward from the lower base section, wherein one of the first and second arms define a slot dimensioned to receive the tether therethrough.

17. The interchangeable EAS pedestal system of claim 1, wherein the base comprises electronic components for powering the EAS pedestal system, and wherein the frame is electrically connected to the electronic components in the base.

18. The interchangeable EAS pedestal system of claim 1, wherein the frame is removeable from the EAS pedestal system, and is replaceable with a different frame.

19. A method of reconfiguring an EAS pedestal system comprising:
providing an EAS pedestal system comprising a base and a first frame removably connected to the base;
removing the first frame from the base; and
connecting a second frame to the base.

20. The method of reconfiguring an EAS pedestal system of claim 19, wherein the base comprises a pair of arms extending upward dimensioned to engage with the first frame or the second frame.
